(19) United States
(12) Patent Application Publication
(10) Pub. No.: US 2016/0255322 A1
(43) Pub. Date: Sep. 1, 2016

(54) USER ADAPTIVE 3D VIDEO RENDERING AND DELIVERY

(71) Applicant: VID SCALE, INC., Wilmington, DE (US)

(72) Inventors: Louis Kerofsky, San Diego, CA (US); Yuriy Reznik, Seattle, WA (US); Eduardo Asbun, San Diego, CA (US)

(73) Assignee: VID SCALE, INC., Wilmington, DE (US)

(21) Appl. No.: 15/027,916

(22) PCT Filed: Oct. 7, 2014
(86) PCT No.: PCT/US2014/059473

§ 371 Date: Apr. 7, 2016

Related U.S. Application Data
(60) Provisional application No. 61/887,743, filed on Oct. 7, 2013.

(51) Int. Cl. H04N 13/00; H04N 13/02; H04N 13/04

(52) U.S. Cl. CPC H04N 13/0014; H04N 13/0059; H04N 13/0484; H04N 13/0278

(57) ABSTRACT

User adaptive 3D video rendering is disclosed. Content may be displayed on a display. A user's position relative to the display and/or a user's direction of view relative to the display may be determined. A user interface of the content may be adjusted based on the user's position and/or the user's direction of view. Adjusting a user interface may include adjusting the perspective of a view of the content displayed on the display. Adjusting a perspective of the view may include determining an adjusted view of the content from available views based on the user's position and/or the user's direction of view. The available views of the content may be requested from a server. A subset of the available views may be received from the server, for example, based on the user's position and/or the user's direction of view. The adjusted view may be displayed on the display.

### CROSS-REFERENCE TO RELATED APPLICATIONS

This application claims priority to U.S. Provisional Patent Application Ser. No. 61/887,743, filed Oct. 7, 2013, which is incorporated herein by reference in its entirety.

### BACKGROUND

Three-dimensional (3D) movies are displayed in theatres. The director of a 3D movie may control the viewpoint and/or the perspective of a 3D scene. There may be assumptions used by the director to produce 3D effects. For example, these assumptions may include assuming that a user's position is essentially constant throughout the show and/or that the screen is in a fixed position. These assumptions may limit the number of views required to be created by a content producer. In 3D movies there may be a view for each eye. For example, the impression of depth and 3D experience may be generated by providing a different view to each eye via 3D glasses (e.g., active or passive glasses). A fixed relative relation between the user and the display may be used to create a controlled experience in a 3D environment.

As mobile devices are more commonly used for viewing video content, such devices are likely to be increasingly used for 3D video consumption. In such devices, which may have smaller displays, a user's position may vary significantly relative to the display. The motion of the viewer relative to the screen may violate the assumptions used in creating 3D content for larger format presentation and therefore may inhibit the sensation of depth and other 3D characteristics.

### SUMMARY

Systems, methods, and instrumentalities are disclosed for performing user adaptive 3D video rendering. A method may be performed by a processor, for example a processor of a client device. Content (e.g., photo, video, or the like) may be displayed on a display (e.g., a display of a client device). A user's position relative to the display and/or a user's direction of view relative to the display may be determined. For example, an input may be received from a sensor. The sensor may include a camera. The user's position and the user's direction of view may be determined based on the input from the sensor.

A user interface (UI) of the content may be adjusted based on the user's position and the user's direction of view. Adjusting a user interface (UI) of the content may include adjusting the perspective of a view of the content displayed on the display. An adjusted view of the content may be determined from a plurality of available views based on the user's position and the user's direction of view. The plurality of available views of the content may be requested from a server (e.g., via a network). A subset of the plurality of available views may be received from the server, for example, based on the user's position and the user's direction of view. Determining the adjusted view of the content may include interpolating a received view to create the adjusted view. The adjusted view may be displayed on the display.

### BRIEF DESCRIPTION OF THE DRAWINGS

FIG. 1A is a system diagram of an example communications system in which the disclosed subject matter may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of another example radio access network and an example core network that may be used within the communications system illustrated in FIG. 1A.

FIG. 1E is a system diagram of another example radio access network and an example core network that may be used within the communications system illustrated in FIG. 1A.

FIG. 2 is a diagram illustrating an example of motion parallax.

FIG. 3 is a diagram of an example of a user adaptive 3D video rendering system.

FIG. 4 illustrates an example method of implementing the disclosed subject matter.

FIG. 5 illustrates an example method of implementing the disclosed subject matter.

FIG. 6 illustrates an example method of implementing the disclosed subject matter.

FIG. 7 illustrates an example method of implementing the disclosed subject matter.

### DETAILED DESCRIPTION

A detailed description of illustrative examples will now be described with reference to the various figures. Although this description provides a detailed example of possible implementations, it should be noted that the details are intended to be examples and in no way limit the scope of the application.

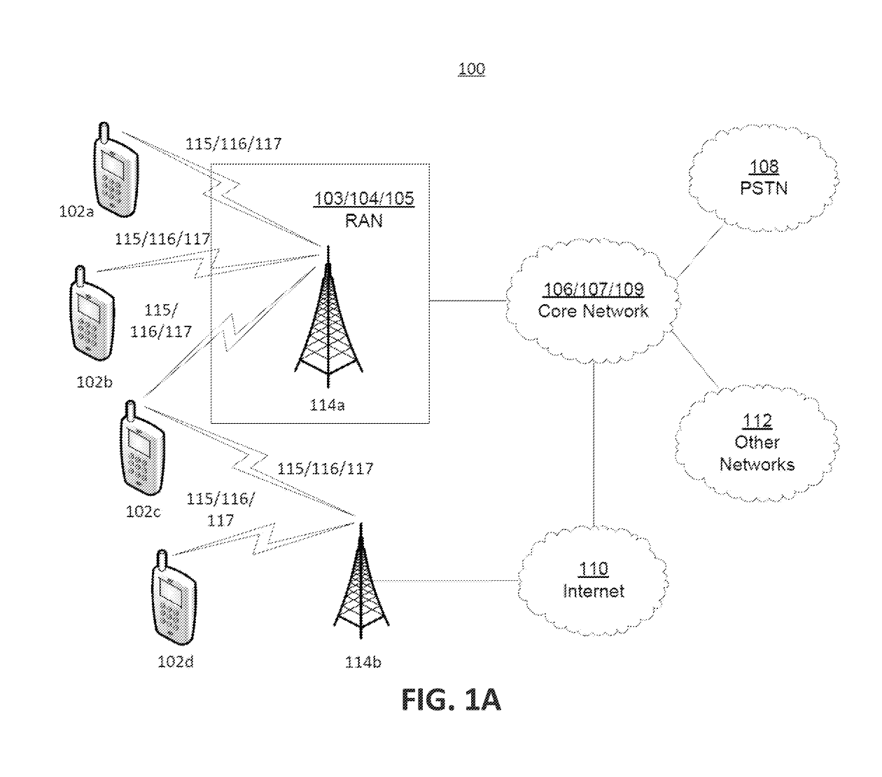

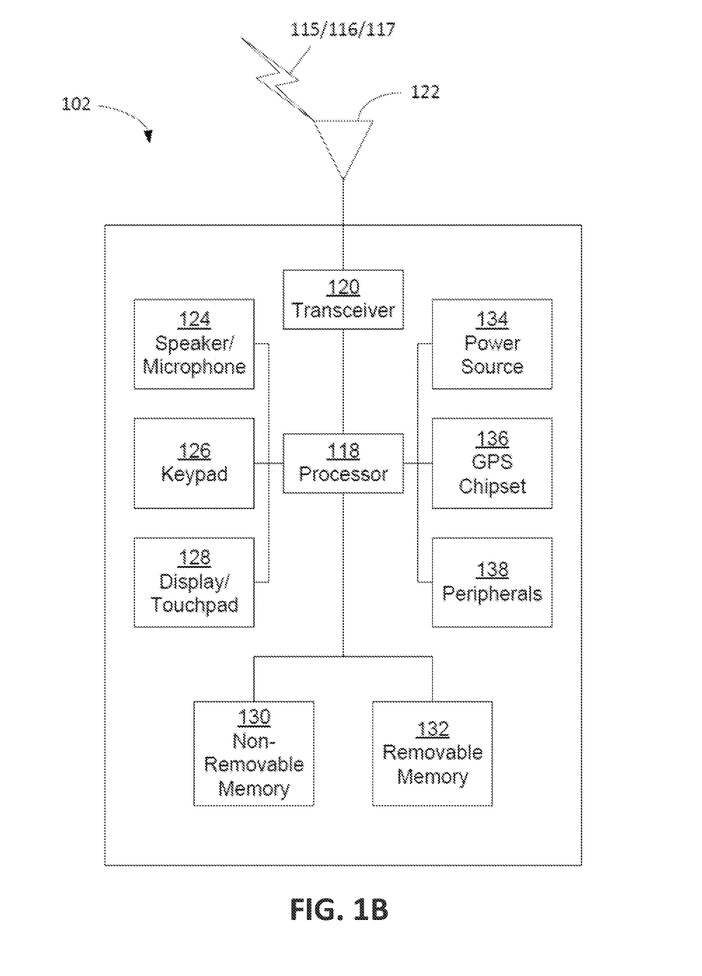

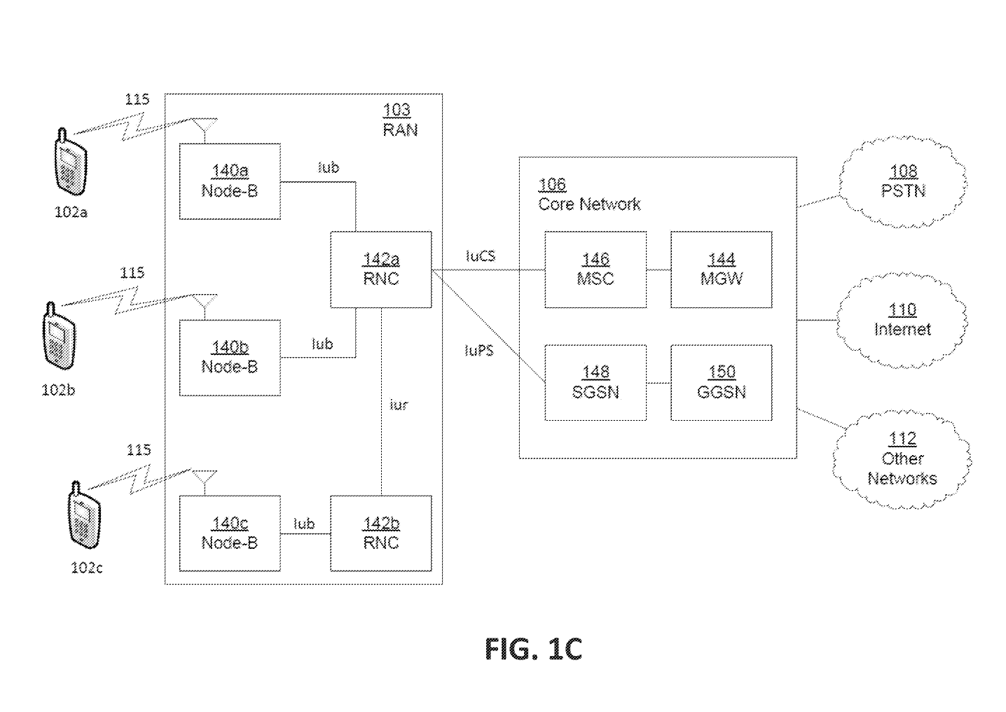

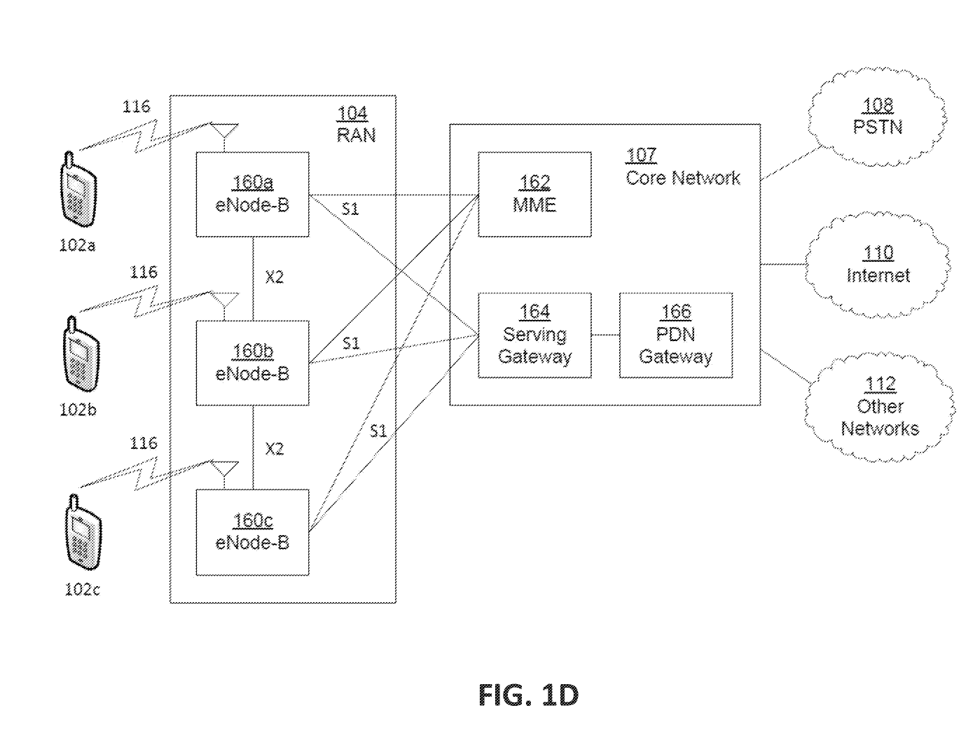

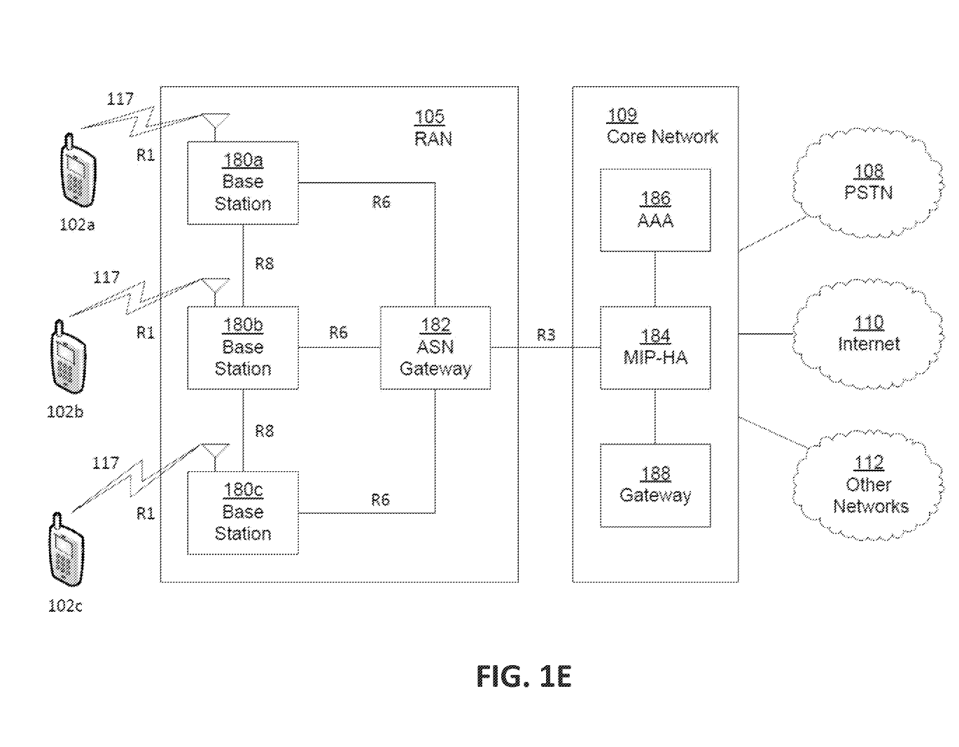

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed systems and methods contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a. 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, e.g., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA. OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a. 102b, 102c may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like. The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109 that may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, e.g., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any subcombination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR. UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138 that may include one or more software and/or hardware modules that provide additional features, functionality, and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth®, module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112 that may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166 that may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b. 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b. 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a. 102b, 102c between the RAN 105 and the other ASNs. The communication link between the core network 109 and the other core networks may be defined as an R5 reference, which may include protocols for facilitating interworking between home core networks and visited core networks.

The disclosed systems and embodiments may assist in creating an intuitive interaction with a device being used to view 3D content by using a camera as input to allow a user to interact with the device by detecting changes of changing viewer position and viewer direction of view relative to the display. The disclosed systems and methods may be used to create the impression of depth when displaying content on a flat 2D display by using such a camera to track a viewer position, a direction of view, and/or a gaze point and modifying the image rendered for the display accordingly. A camera, a display, and a 3D representation of an object or a scene to be displayed may be used to improve the presentation of 3D content. The representation of an object or a scene may consist of a model of synthetic content as in a video game or image captures of various views of a natural object. A client device equipped with a camera and a 2D display may communicate over a network to a server that may contain multi-view representations of video content. The user may freely vary the viewpoint used to display this content while the camera tracks the viewer to acquire and/or provide images rendered for a custom viewpoint and to allow free navigation within the scene.

Traditional 3D rendering may differ from free viewpoint 3D. In traditional 3D implementations, such as at a theater, a director may control a viewpoint and a direction of gaze into 3D scene based on assumptions that a user's position is essentially fixed and remains constant throughout the presentation of the 3D content and that the screen on which such content is displayed is in a fixed position. This limits the number of views that need to be created by the content producer. For example, in 3D movies, there may be a view for each eye. A means of generating the impression of depth and the 3D experience in such embodiments is to provide a different view to each of a viewer's eyes, by using active or passive glasses, for example. The fixed relative relation between the viewer and the display may be used to create a controlled experience in a 3D environment.

In smaller displays, the user's position may vary significantly relative to the display, making motion parallax a strong depth cue. The motion of the viewer relative to the screen prevents content producers from relying on the assumption used in traditional stereoscopic 3D presentations that the viewer is in a fixed and constant position relative to the display. Motion parallax may help create the sense of depth when a viewer moves relative to a display, while a lack of motion parallax in the rendering used in traditional 3D systems may diminish a sense of realism.

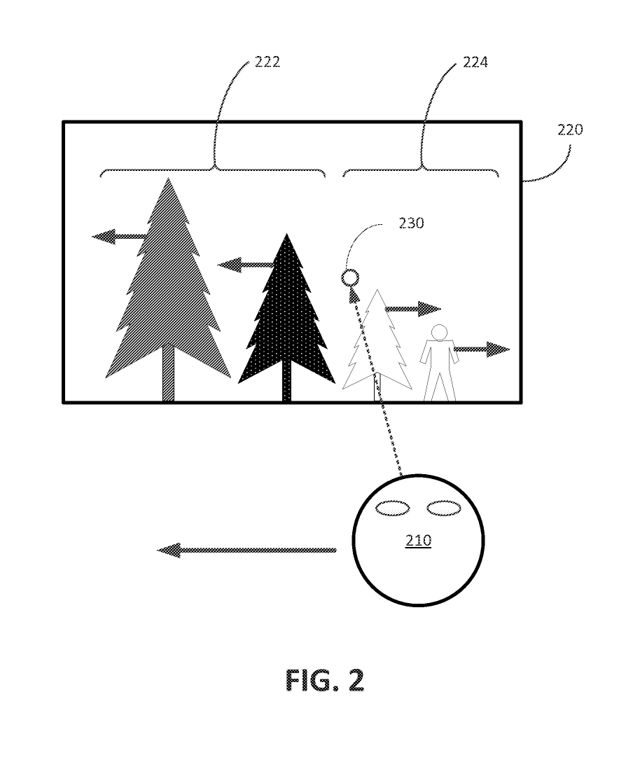

Motion parallax is a depth cue that results from a viewer's motion relative to a scene. Motion parallax may be present in 2D and 3D projections and may be exploited in 2D display applications to create a sense of depth and realism. Motion Parallax may be a displacement or a difference in the apparent position of an object viewed along two different lines of sight. Motion parallax is the difference in the apparent position of an object when the viewer changes the viewer's viewing position, for example, when the viewer moves to the left or right relative to a display. For example, FIG. 2 illustrates example viewer 210 gazing at an image in display 220 (which may be a display or other representation of an image or any actual view of the real world, such as through a window), and specifically gazing at fixed point 230. Viewer 210 may be moving to the left. Objects shown in display 220 may appear to move relative to fixed point 230 even though they are actually motionless. For example, as viewer 210 moves to the left, objects 222 in display 220 may appear to move to the left while objects 224 in display 220 may appear to move to the right. Where display 220 is displaying generated or projected images, the 2D projections of the objects may be moved in response to the movement of viewer 210 to improve the sense of depth experienced by viewer 210. The magnitude and/or direction of apparent motion of objects such as objects 222 and 224 may be determined based at least on a distance from fixed point 230 and the relative motion of viewer 210.

Elements used in the disclosed systems and methods for rendering the effect of motion parallax may include tracking a viewer's position, selecting an appropriate viewpoint, and/or rendering appropriate image projection on a display. Motion parallax effects may be used for synthetic content by, for example, viewer head tracking and modifying a view point used to render synthetic 3D objects onto 2D displays.

A motion parallax depth cue may be used. The depth effect may be used in 2D display technology to allow a viewer to move and “look behind objects.” User adaptive viewpoint and user control of navigation within a 3D scene may be distinct functionalities enabled by a display system exploiting motion parallax. The sensation of realism provided by a traditional stereoscopic 3D display may be augmented by the use of motion parallax-based rendering.

A computer vision technique for face detection may be used in the disclosed subject matter to determine a location and size of one or more human faces in images and/or video. Additional body features (e.g., eyes, nose, ears) may be detected to increase the probability of correct face detection.

Eye tracking may be used in the disclosed systems and embodiments to measure a point of gaze (where a person is looking) and/or a motion of an eye relative to an associated head. A camera may focus on one or both eyes and record their movements as the viewer looks at video shown on a display. The results recording eye movements may be used to determine a region of interest in the video. Gaze estimation may be an extension of eye tracking where a gaze direction may be approximated. The results of gaze estimation may be used to narrow down the region of interest in video.

When a 3D model of a scene exists, arbitrary 2D views may be generated using various projection methods such as those used in computer graphics. For example, a computer game may include a game engine that has a 3D model of a scene and that generates projections based on a player's position. Natural content captured, for example, by a camera may have a limited number of views available for rendering due to a limited number of captures and/or communication bandwidth limits that prevent all possible views from being sent from a server to client for instance. In either scenario, it may be necessary to synthesize a view needed for rendering. View interpolation may be used to address this issue. View interpolation may be a process of synthesizing novel images of a scene from a different point of view than the points of view used as references in the available captures or projections. Any view interpolation methods may be used in the disclosed systems and methods, such as 3D model-based rendering and image-based rendering.

For example, low complexity methods for interpolating a desired view between two existing views may be used. This may be useful when the content is represented as a set of discrete views, such as in Multi-View Coding (MVC), and an additional interpolated viewpoint is desired. An image disparity map may be used that describes how many pixels in one view of an image are offset in a corresponding image for another viewpoint of the same scene. Such disparity maps may correspond to known views used for a basis of interpolation may be computed using various algorithms, including a “forward” method and a “backward” method, which differ in how the disparity maps are constructed and used. The backward method may be most appropriate for streaming applications where a client desires to locally interpolate additional views. The ‘backward method may not require sending additional disparity maps to a client for view interpolation needs.

Explicit depth information may be used in rendering desired views rather than a disparity-based method. This method may be referred to as depth-based image rendering (DBIR). When the content is in the form of 2D images plus a depth map (e.g., video plus depth (VpD) format), DBIR may be used for generating interpolated views.

View interpolation methods of all types may need to determine and generate data for pixels that cannot be directly reproduced from the anchor views used for interpolation. This process may be known as “in-painting” and various algorithms may be used to provide in-painting, including interpolation from background pixel values.

Rendering may be the process of preparing an image to be sent to a display device. Rendering may include specifying parameters for a current viewpoint and computing an appropriate projection to be presented on a 2D display, for example, when a scene is represented as a 3D model. Rendering may select appropriate parameters for the view needed for display and may control the view interpolation algorithm, for example, when natural content is represented as discrete views or in VpD format.

Adaptive multi-view video streaming may be used. A stereoscopic display may be driven by two views that may be selected based on tracking a viewer's head position. A client may request a base layer including M frames and two enhancement layer frames (e.g., in each time instance), for example, based on the views corresponding to a d-frame and a prediction of a trajectory of a viewer's head motion. At a decoder, three levels of decoding may be used for each of the two views needed at each time instance. If a desired frame of a view exists in a high quality representation, that frame may be decoded and used for display. If a high quality representation does not exist, a check may be performed to determine if a view exists in a low quality representation (e.g., one of the M base layer views). If so, that frame may be used for display. If no representation is available, a simple frame copy may be used to conceal the lack of the desired view.

There may be challenges related to using motion parallax to create the impression of depth on a 2D display. If a camera is capturing one or more images of a viewer in front of a display, an estimate of the viewer's head position and the direction of view may be provided to the system. Given a location of a viewer's face, a viewer's direction of view, and/or a representation of the content as a plurality of views, a view may be constructed corresponding to the viewer's direction of view and rendered on a display device. Given a limitation on bandwidth, supplying views sufficient to provide a smooth viewing experience when a viewer moves (e.g., when view interpolation is coupled with tracking the head position and direction of view) may be a challenge. Appropriate subsampling of view positions and compression for video streams of these views may be determined.

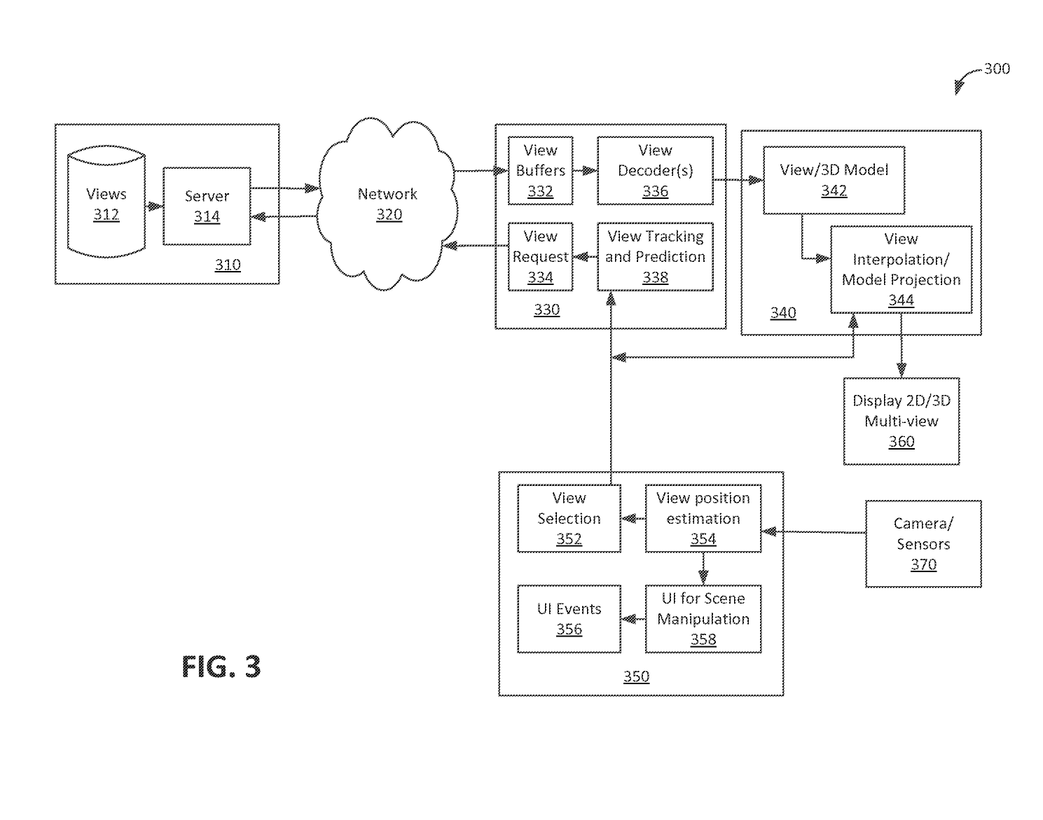

FIG. 3 illustrates an example of a user adaptive 3D video rendering system 300 that may be used to implement aspects of the instant disclosure. Note that while the functions and devices described in regard to FIG. 3 may be grouped together and/or presented in a particular configuration, each of the described functions and devices may be implemented in any manner and with any number and type of devices, any software means, and any combination thereof without departing from the scope of the instant disclosure.

Unit 350 in system 300 may receive input from one or more cameras and/or one or more other sensors (e.g., user-facing camera on a mobile device, table, laptop, etc.), represented as camera/sensors 370 in FIG. 3. Unit 350 may monitor a viewer's position and/or direction of view using such received input for user interface (UI) purposes (e.g., signaling direction of motion in a game) and/or for selecting a desired view for a user's viewpoint.

Unit 340 in system 300 may receive input regarding a selected viewpoint from view selection function 352 of unit 350 and may access a set of potential views buffered at unit 340 to produce a view rendered to a display device such as display 360. This may be accomplished using interpolation at function 344 if a selected view is not available. Rendering for a specified viewpoint may be performed using a 3D model of content obtained from 3D model function 342 if available.

Unit 330 may handle buffering of views that may be available to a client device. A selected view may be an input to view tracking and prediction module 338 from unit 350. Additional views may be requested by view request function 334 when a predicted view position indicates additional viewpoints may be used for generating subsequent views.

Unit 310 may include server 314 that may have, or have access to, views 312 that may be stored in any manner, including in a database. Such a collection of representations of content may include views from different viewpoints. Server 314 may select a compressed representation of an appropriate view and forward it to a client device. Communication between units 310 and 330 may be facilitated over network 320, which may be any type of network, including a wired network, a wireless network, or any combination thereof.

In user-adaptive 3D video rendering systems and methods as described herein, the rendering may be adaptive to a location of a viewer position and a viewer's direction of view as detected by a camera or other sensors and the depth of the content. Referring again to system 300 of FIG. 3, an example system may have components for view selection and for rendering, such as view selection function 352 of unit 350 that may select views and view interpolation/model projection function 344 of unit 340 that may perform rendering. View selection function 352 may estimate a viewer position relative to a display and may compute an appropriate viewpoint for a rendering process. The rendering process performed by function 344 may receive a selected viewpoint from view selection function 352 and may generate output for a display, 2D or otherwise, such as display 360. The rendering process performed by function 344 may have access to discrete views of a scene and it may perform view interpolation using such views. Such views may be obtained from views/3D model function 342 of unit 340. The rendering process may also, or instead, have access to content in a 2D plus depth format where DBIR may be used for interpolation and/or rendering. The rendering process may have access to a 3D model of the content and may calculate appropriate projections using such models. Models may be obtained from views/3D model function 342 of unit 340. This method may support intuitive user interaction with static 3D objects and/or with modeled 3D environments on a 2D display via motion parallax-based rendering tied to viewer position estimate. In such implementations, the availability of a 3D model or a large set of views of a natural object may affect the results.

User direction of view may be used to control operation and presentation of images in a scene. Referring again to system 300 of FIG. 3, an application may accept user input by detecting UI events via UI events function 356 of unit 350. Such input may be used to determine how to navigate within a scene. For example, a typical 3D game may use UI events generated by manipulation of a keyboard, a mouse, touch inputs, or any other type of inputs, to navigate within a scene. Hardware, for example in combination with software, may be used to control operation within a scene and may or may not directly control the rendering position within a scene. A portion of system 300 may be used to determine a viewpoint and generate UI events to control a scene or other interaction with the device.

A camera or any other type of sensor or combination thereof (e.g., thermal, infrared, light detection and ranging (LIDAR), 3-D LIDAR, 3-cameras, etc.) may track a viewer's face location and direction of view. Gaze tracking may also be performed using such sensors. A user interface may use a viewer's direction of view to control interaction. In an example, a location of a viewpoint on the screen may be mapped to a UI input. For instance, display areas may be divided into regions and a presence (e.g., for any amount of time or at least a threshold amount of time) in each position may be mapped to an action in a game as shown in Table 1 below.

TABLE 1
Example viewpoint to UI actions

| Viewpoint location | Action |
|---|---|
| Left 1/3 | Scene rotates to the right |
| Center 1/3 and Top 1/3 | Move forward |
| Right 1/3 | Scene rotates to the left |

These operations may be modified. For example, a speed of rotation may be changed based upon how long a viewer's viewpoint remains in a particular area. The speed of rotation may also, or instead, vary with a distance of a viewer's viewpoint from the center of a screen.

The disclosed systems and methods may be used to provide content to devices, such as mobile devices, that may not have the local storage capacity or available bandwidth to acquire and/or store the data needed to produce satisfactory 3D images. Such capabilities may be significant to the use of applications such as interactive video streaming or cloud based gaming on mobile devices.

Referring again to system 300 of FIG. 3, a user device may determine the views needed to best present a quality 3D image to a user. For example, a determination of views may be based on any of the criteria described herein and may be performed at unit 340, which may be executing and/or installed on a user device. For instance, view interpolation/model projection function 344 may determine that a particular view is available and would provide the best realistic 3D image to a viewer. Alternately, or additionally, view selection function 352 may select a view based, for example, on the location of the user relative to the display and/or on the user's gaze point. Function 344 and/or function 352 may transmit a request to unit 310 for such a view, e.g., via unit 330, view tracking and prediction function 338, view request function 334, and/or network 320. Unit 310 may respond with the requested view, which may be stored in view buffers 332 and/or decoded by view decoder 336 and provided to unit 340 for display on display 360. Unit 310 may perform interpolation to generate the view and provide it to unit 340, for example, in situations where unit 340 determines a particular view but the view may not be present at unit 310. The information used by unit 310 to determine image selection or generation may be any data that may facilitate such a process, such as scene or view identifier(s), viewer location information, viewer viewpoint information, depth information for a scene, 3D model information for a scene, and any other information set forth herein or that may otherwise assist in image selection and/or generation.

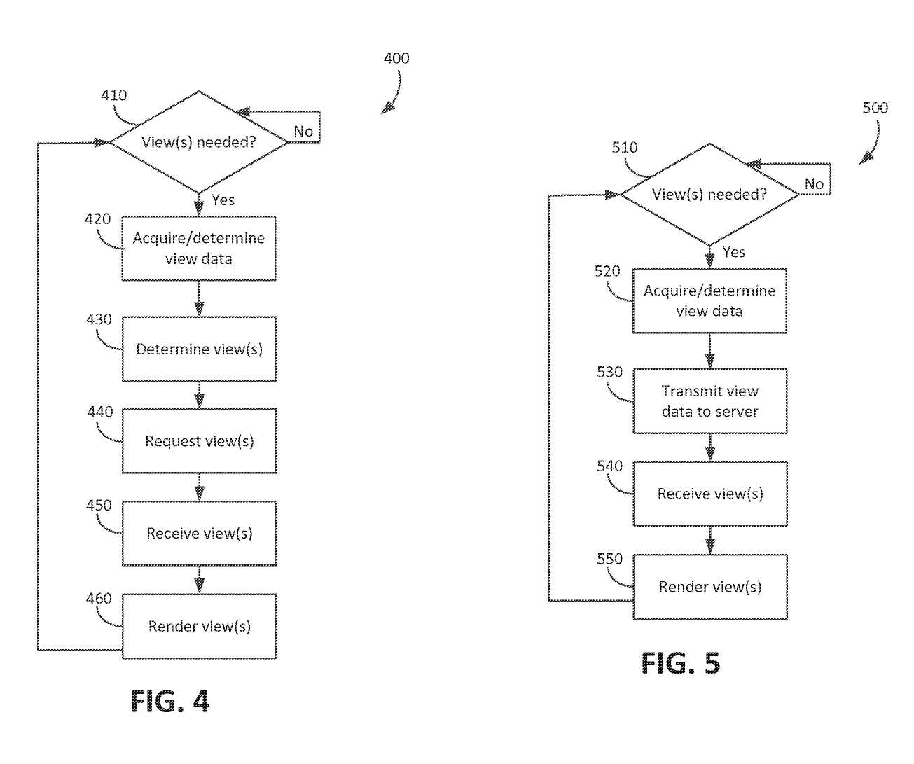

Method 400 shown in FIG. 4 illustrates an example of such an embodiment. At block 410, a user device may determine whether there is currently a need for one or more views. This may be determined based on UI input, arrival of a time instance, or any other criteria. If there is currently no need for one or more views, method 400 remains at block 410 until a view is needed.

If a view is needed, a user device may determine and/or acquire any of the data that may be used to determine a view or set of views at block 420. As noted, this data may be any of the data disclosed herein that may be used to facilitate the selection or generation of a view. At block 430, a user device may determine one or more views based on this data. At block 440 a request for the determined view(s) may be transmitted to a server or other system that may store and serve such views. At block 450, the view(s) may be received and displayed at block 460, with the method returning to block 410 for the next view acquisition.

A user device may provide to another device information that may be used to determine images that best present a believable 3D image to a user. For example, a determination of images may be based on any of the criteria described herein and may be performed at unit 310, which may be executing and/or installed on a device remote from a user device. For example, unit 340 and/or view interpolation/model projection function 344 may determine information that may be used to generate or select a view. Alternately unit 350 and/or view selection function 352 may determine information that may be used to generate or select a view. The information determined by unit 340 and/or unit 350 may be any data that may facilitate such a process, such as scene or view identifier(s), viewer location information, viewer viewpoint information, and any other information set forth herein or that may otherwise assist in image selection and/or generation. This information may be transmitted to unit 310, e.g., via unit 330, view tracking and prediction function 338, view request function 334, and/or network 320. Unit 310 may respond by selecting a view based on the information or interpolating a view based on the information and on other available views. The requested view may be sent via unit 330, where it may, for example, be stored in view buffers 332 and/or decoded by view decoder 336. The requested view, e.g. after decoding, may be sent to unit 340. The requested view or a modified, modelled, or interpolated view based on the requested view may be provided by view interpolation/model projection function 344 for display on display 360.

Method 500 shown in FIG. 5 illustrates an example of such an embodiment. At block 510, a user device may determine whether there is currently a need for one or more views. This may be determined based on UI input, arrival of a time instance, and/or any other criteria. If there is currently no need for one or more views, method 500 remains at block 510 until a view is needed.

If a view is needed, a user device may determine and/or acquire any of the data that may be used to determine or generate a view or set of views at block 520. As noted, this data may be any of the data disclosed herein that may be used to facilitate the selection or generation of a view. At block 530 a request for one or more view(s) may be transmitted to a server and/or other system that may store and serve such views. The server and/or system may acquire or generate one or more views based on the information provided by the user device, for example, as described herein. The server and/or other system may transmit the view(s) to the user device. At block 540, the view(s) may be received. At block 550, the view(s) may be displayed. The method may return to block 510 for the next view acquisition.

A user device may perform interpolation after acquiring one or more view(s) upon which such interpolation may be based. For instance, a determination of view(s) needed for interpolation of a view may be based on any of the criteria described herein and may be performed at unit 340 and/or view interpolation/model projection function 344. This determination may be based on information such as scene or view identifier(s), viewer location information, viewer viewpoint information, and any other information set forth herein or that may otherwise assist in image selection and/or generation. This information may be transmitted to unit 310, e.g., via unit 330, view tracking and prediction function 338, view request function 334, and/or network 320. Unit 310 may respond by selecting a view based on the information or interpolating a view based on the information and on other available views. View interpolation/model projection function 344 may determine that one or more particular views are available and may transmit a request to unit 310 for such view(s), e.g., via unit 330, view tracking and prediction function 338, view request function 334, and/or network 320. The requested view(s) may be sent to unit 340 (and may, e.g., be stored in view buffers 332 and/or decoded by view decoder 336) for use in interpolating a view to be presented on display 360.

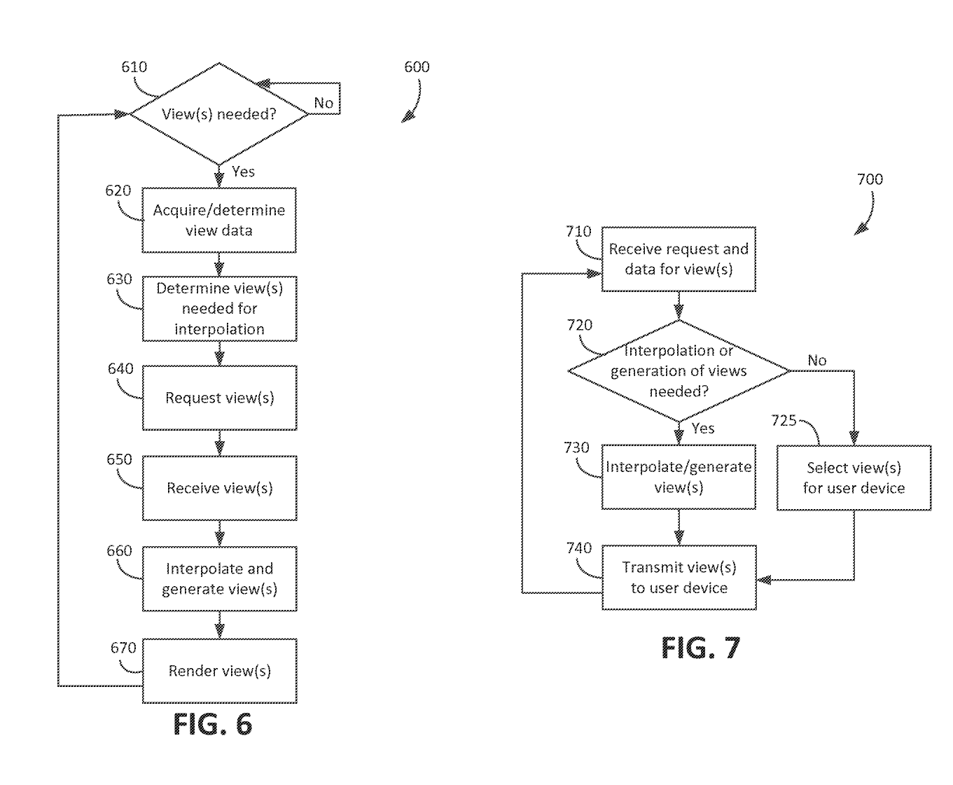

Method 600 shown in FIG. 6 illustrates an example of such an embodiment. At block 610, a user device may determine whether there is currently a need for one or more views. This may be determined based on UI input, arrival of a time instance, and/or any other criteria. If there is currently no need for one or more views, method 600 remains at block 610 until a view is needed.

If a view is needed, a user device may determine and/or acquire any of the data that may be used to determine a view or set of views that may be used for interpolation or view generation at block 620. As noted, this data may be any of the data disclosed herein that may be used to facilitate the selection or generation of a view. At block 630, a user device may determine the one or more views needed for interpolation or generation based on this data. At block 640 a request for the determined view(s) may be transmitted to a server or other system that may store and serve such views. At block 650, the requested view(s) may be received and interpolation and generation of one or more views may occur at block 660. The generated view(s) may be displayed at block 670, with the method returning to block 610 for the next view acquisition.

Method 700 shown in FIG. 7 illustrates a method that may be used at a device that provides views to other devices, such as unit 310 in FIG. 3. At block 710, a request may be received from a user device indicating that the device currently has a need for one or more views. The request may simply provide data as described herein, allowing the server or device executing method 700 to determine whether to select a view or generate a view. The request may indicate one or more specific views or may explicitly request interpolation, e.g., based on one or more indicated particular views. This may be determined based on UI input, arrival of a time instance, and/or any other criteria.

At block 720, the server or system may determine whether interpolation and/or view generation is needed. If not, the one or more requested views may be selected, e.g., based on the request received at block 710 and/or data associated therewith, at block 725 and transmitted to the user device at block 740.

If view interpolation and/or generation is needed, the one or more requested views may be generated, e.g., using interpolation based on the request received at block 710 and/or data associated therewith, at block 730 and transmitted to the user device at block 740.

The disclosed systems and methods exploit viewpoint detection and other viewer related capabilities of modern mobile devices to determine the needed views at the client. Local view interpolation at a viewer device may be used to limit the number of unique views sent to the client while allowing fine precision in motion to alter the rendering (e.g., based on exploiting motion parallax). Viewpoints (e.g. the change in a user's viewpoint over time) may be tracked and used to estimate future needed views. Views necessary to support interpolation of one or more estimated future views may be retrieved from a set of views on a server or other system. The use of a relatively sparse set of views and streaming only the views necessary to support interpolating the views needed by the rendering module or only the views needed for presentation at the client may reduce the bandwidth and other resource demands on the viewer system.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for rendering video content, the method comprising:
determining, at a first device, view data;
determining, at the first device, an identifier associated with a first view corresponding to the view data;
transmitting, from the first device to a view server, a request for the first view, wherein the request for the first view comprises the identifier associated with the first view;
receiving, at the first device, the first view; and
rendering, at the first device, the first view.

2. The method of claim 1, wherein the view data comprises at least one of a viewer's viewpoint, user input, or a viewer's position.

3. The method of claim 1, wherein the first view is an interpolated view.

4. The method of claim 3, wherein the first view is interpolated based on a plurality of other views.

5. The method of claim 1, wherein the first view comprises a plurality of views.

6. The method of claim 1, wherein the request for the first view comprises at least a subset of the view data.

7. The method of claim 1, further comprising storing the first view in a buffer.

8. A wireless transmit/receive unit (WTRU) comprising:
a processor configured to:
determine view data;
determine an identifier associated with a first view corresponding to the view data; and
render the first view on a display;
a transmitter configured to transmit a request for the first view to a remote device, wherein the request for the first view comprises the identifier associated with the first view; and
a receiver configured to receive the first view.

9. The WTRU of claim 8, wherein the first view comprises a plurality of views.

10. The WTRU of claim 8, wherein the request for the first view comprises the view data.

11. The WTRU of claim 10, wherein the view data comprises at least one of a viewer's viewpoint, user input, or a viewer's position.

12. The WTRU of claim 8, wherein the processor is further configured to interpolate a second view based on the first view and a third view.

13. The WTRU of claim 8, wherein the processor is further configured to interpolate a second view based on the view data.

14. The WTRU of claim 8, wherein the processor is further configured to interpolate a second view based on the first view.

15. A method for rendering video content, the method comprising:
determining at a first device, view data:
determining at the first device, an identifier associated with a first view corresponding to the view data;
transmitting, from the first device to a view server, a request for a first view, wherein the request for the first view comprises the identifier associated with the first view;
receiving, at the first device from the view server, the first view;
interpolating, at the first device, a second view based on the first view; and
rendering, at the first device, the second view on a display.

16. The method of claim 15, wherein the first view comprises a plurality of views.

17. The method of claim 15, wherein the request for the first view comprises the view data.

18. The method of claim 17, wherein the view data comprises at least one of a viewer's viewpoint, user input, or a viewer's position.

19. The method of claim 15, wherein interpolating the second view based on the first view comprises interpolating the second view based on the first view and a third view.

20. The method of claim 15, wherein the processor is further configured to interpolate the second view based on the view data.
